(19) United States
(12) Patent Application Publication
(10) Pub. No.: US 2014/0236487 A1
(43) Pub. Date: Aug. 21, 2014

(54) METHODS AND COMPUTING SYSTEMS FOR PROCESSING SEISMIC DATA

(71) Applicant: Westerngeco L.L.C., Houston, TX (US)

(72) Inventor: WOUTER PEPIJN KIMMAN, CRAWLEY (GB)

(73) Assignee: Westerngeco L.L.C., Houston, TX (US)

(21) Appl. No.: 14/092,001

(22) Filed: Nov. 27, 2013

Related U.S. Application Data
(60) Provisional application No. 61/767,639, filed on Feb. 21, 2013.

(51) Int. Cl. G01V 1/30

(52) U.S. Cl. CPC G01V 1/303
USPC 702/18

(57) ABSTRACT

Methods and computing systems for processing seismic data are disclosed. In one embodiment, a method for processing seismic data comprises receiving seismic data that includes active data corresponding to an active shot from a seismic source. The processing includes processing at least a portion of the active data using a passive data processing technique.

### CROSS REFERENCE TO RELATED APPLICATIONS

This application claims the benefit of U.S. Provisional Patent Application No. 61/767,639 filed Feb. 21, 2013, which is incorporated herein by reference in its entirety.

### BACKGROUND

Seismic surveying generally includes the process of recording reflected seismic waves from beneath the subsurface in order to model geological structures and physical properties of the earth. For instance, the aim of a seismic survey may be to depict the physical properties of a reservoir.

Seismic signals returned from the earth can include both an active, desired signal, as well as noise. Various techniques have been proposed for identifying and processing the desired portions of the returned signals, as well as any noise in the signals.

Surface wave analysis of land seismic data can be used to obtain high resolution near-surface shear wave models of the survey area and therefore subsequently attenuate ground-roll noise. However, these techniques are limited to the frequency band of the generated sweep. Despite recent progress in the generation of low frequency energy, ground-roll analysis results in relatively shallow subsurface images.

Processing of the very low frequency band could allow further characterization of shear wave velocity models at larger depth. Cross-correlation techniques (e.g., surface wave interferometry, reference) that might have the potential to deliver value in this frequency regime rely on measuring passively for long periods of time, which is not economically feasible during large active surveys.

Accordingly, there is a need for methods and computing systems that can employ more effective and accurate methods for identifying, isolating, and/or processing various aspects of seismic signals returned from the earth during a survey.

### BRIEF SUMMARY

In an example, a method includes: receiving seismic data, the seismic data including active data corresponding to an active shot from a seismic source; and processing, by a processor, at least a portion of the active data using a passive data processing technique.

In another example, a method includes receiving seismic data and processing, by a processor, the seismic data. The seismic data includes active data corresponding to an active shot from a seismic source. The processing includes identifying a virtual source, and identifying a window corresponding to the virtual source.

In another example, a non-transitory computer readable storage medium, which has stored therein one or more programs, the one or more programs including instructions, which when executed by a processor, cause the processor to perform a method including: receiving seismic data, the seismic data including active data corresponding to an active shot from a seismic source; and processing at least a portion of the active data using a passive data processing technique.

### BRIEF DESCRIPTION OF THE DRAWINGS

For a better understanding of the aforementioned embodiments as well as additional embodiments thereof, reference should be made to the Detailed Description below, in conjunction with the following drawings in which like reference numerals refer to corresponding parts throughout the figures.

FIG. 1A illustrates a simplified schematic view of a survey operation performed by a survey tool at an oil field.

FIG. 1B illustrates a simplified schematic view of a drilling operation performed by drilling tools.

FIG. 1C illustrates a simplified schematic view of a wireline operation performed by a wireline tool.

FIG. 1D illustrates a simplified schematic view of a production operation performed by a production tool.

FIG. 2 illustrates a schematic view, partially in cross section, of an oilfield.

FIG. 3 illustrates a perspective view of an oilfield.

FIGS. 4A-4D illustrate schematic views of noise sources in a survey field.

FIG. 5 illustrates a plot of phase information of a time-frequency transform of a trace in accordance with some embodiments.

FIG. 6A illustrates a schematic view of a survey field in accordance with some embodiments.

FIG. 6B illustrates a plot of a result of a SPAC computation as a function of distance, comparing active and passive recordings in accordance with some embodiments.

FIG. 7A illustrates a plot of a calculated misfit as a function of phase velocity in accordance with some embodiments.

FIG. 7B illustrates a plot of normalized SPAC coefficients as a function of distance from a virtual source in accordance with some embodiments.

FIGS. 8, 8A and 8B illustrate schematic views of windowing data in a survey field in accordance with some embodiments.

FIG. 9A illustrates a phase velocity map of a survey area in accordance with some embodiments.

FIG. 9B illustrates a phase velocity map of survey area derived from active data in accordance with some embodiments.

FIGS. 10A-F illustrate a phase velocity map and corresponding dispersion curves in accordance with some embodiments.

FIG. 11A illustrates a plot of a 3D shear velocity structure in accordance with some embodiments.

FIG. 11B illustrates a plot of a 3D shear velocity structure after merging active data in accordance with some embodiments.

FIGS. 12A-C illustrate stack plots in accordance with some embodiments.

FIG. 13 illustrates a schematic view of a computing system in accordance with some embodiments.

### DETAILED DESCRIPTION

Reference will now be made in detail to embodiments, examples of which are illustrated in the accompanying drawings and figures. In the following detailed description, numerous specific details are set forth in order to provide a thorough understanding. However, it will be apparent to one of ordinary skill in the art that the described techniques may be practiced without these specific details. In other instances, well-known methods, procedures, components, circuits and networks have not been described in detail so as not to obscure aspects of the embodiments.

It will also be understood that, although the terms first, second, etc., may be used herein to describe various elements, these elements are not be limited by these terms. These terms are used to distinguish one element from another and do not imply an order or division of elements unless otherwise specifically stated. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description herein is for the purpose of describing particular embodiments and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses one or more of the associated listed items, including combinations thereof. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., a full set of the components of a wavefield, a full set of source receiver traces, each of a plurality of objects, etc., the methods and techniques disclosed herein may also be performed on a subset of a given thing, e.g., performed on one or more components and/or performed on one or more source receiver traces. Accordingly, in instances in the disclosure where an absolute is used, the disclosure may also be interpreted to be referring to a subset.

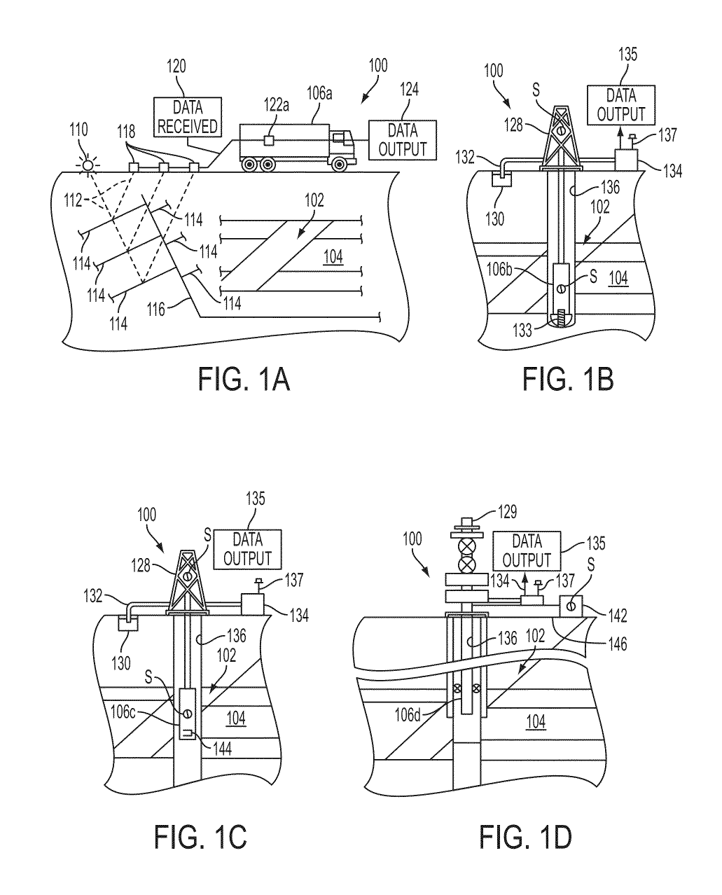

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of the seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106D deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

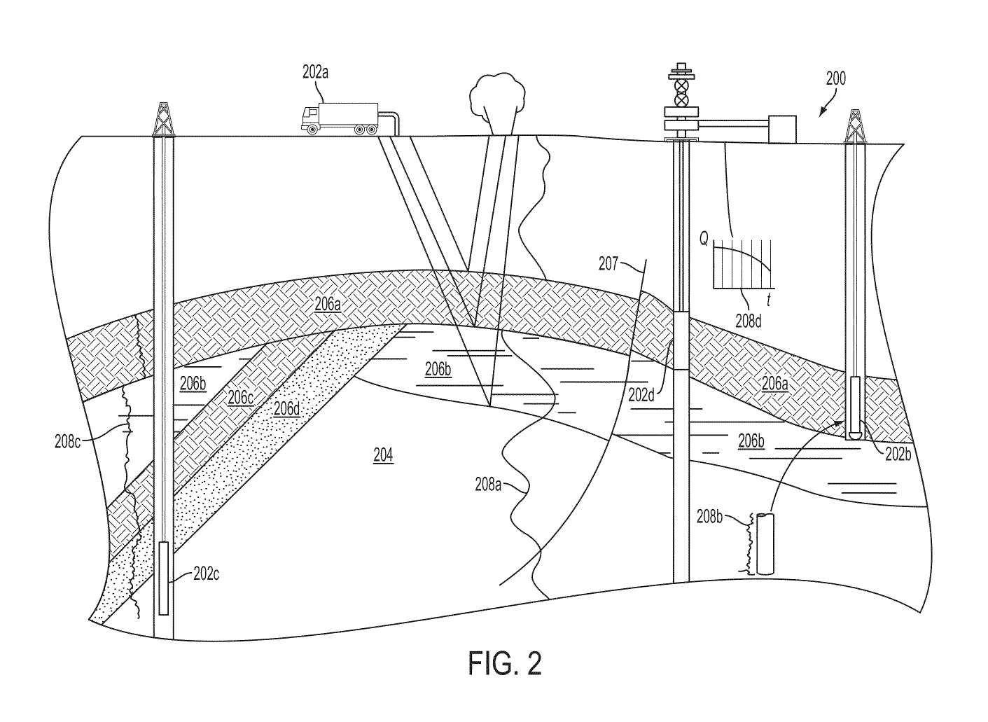

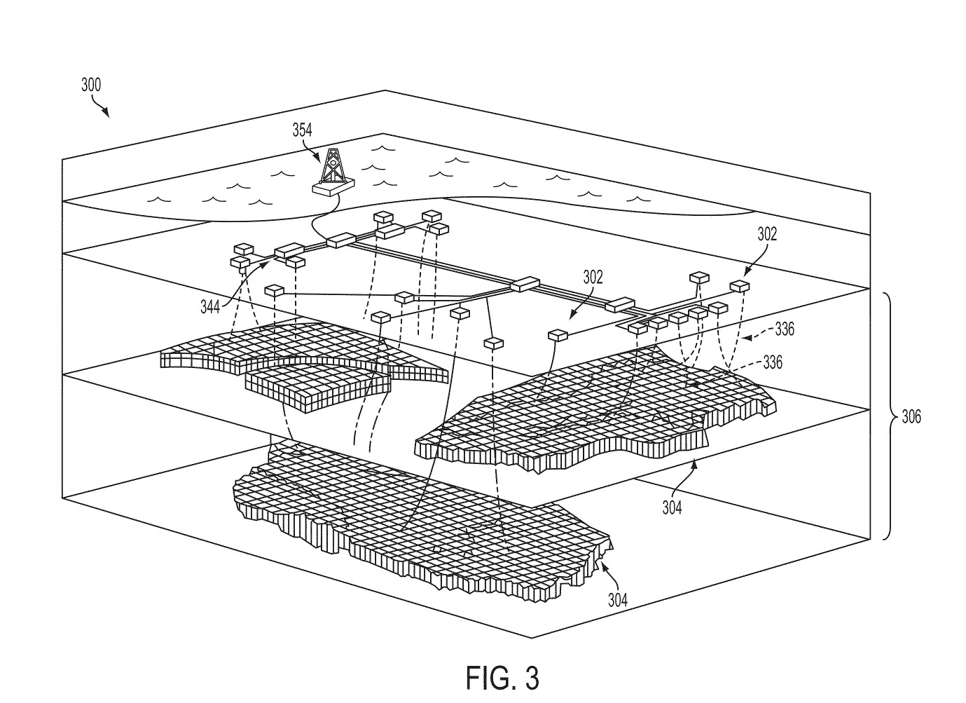

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that provides a resistivity or other measurement of the formation at various depths.

A production decline curve or graph 208d is a dynamic data plot of the fluid flow rate over time. The production decline curve provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, for example below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Seismic data displayed in static data plot 208a from data acquisition tool 202a may be used by a geophysicist to determine characteristics of the subterranean formations and features. The core data shown in static plot 208b and/or log data from well log 208c may be used by a geologist to determine various characteristics of the subterranean formation. The production data from graph 208d may be used by the reservoir engineer to determine fluid flow reservoir characteristics. The data analyzed by the geologist, geophysicist and the reservoir engineer may be analyzed using modeling techniques.

FIG. 3 illustrates an oilfield 300 at which production operations in accordance with implementations of various technologies and techniques described herein may be performed. The oilfield 300 has a plurality of wellsites 302 operatively connected to central processing facility 354. The oilfield configuration of FIG. 3 does not limit the scope of the oilfield application system. The oilfield, or parts thereof, may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores 336 extend through subterranean formations 306 including reservoirs 304. These reservoirs 304 contain fluids, such as hydrocarbons. The wellsites 302 draw fluid from the reservoirs 304 and pass them to the processing facility 354 via surface networks 344. The surface networks 344 have tubing and control mechanisms that control the flow of fluids from the wellsites 302 to the processing facility 354.

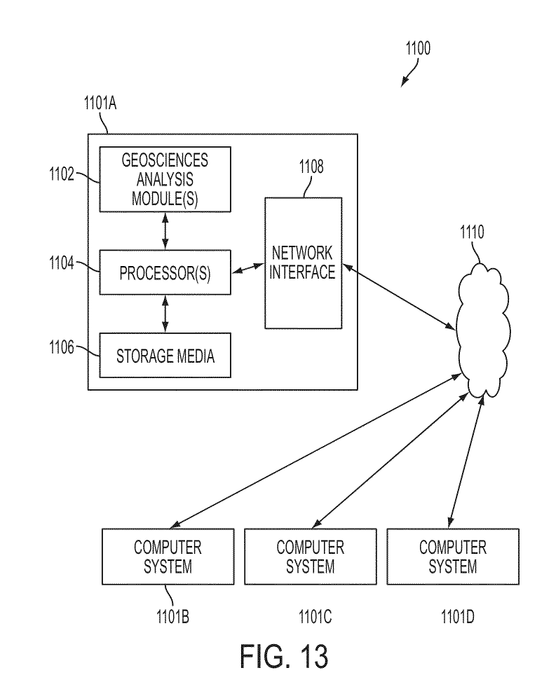

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. It will be appreciated that in the geosciences, various geologic interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 1100, FIG. 13), and/or through manual control by a user who may make determinations regarding whether a given step, action, template, or model has become sufficiently accurate.

In some embodiments, a method is provided to measure the (fundamental mode) Rayleigh wave phase velocity of low frequencies (˜0.5-3 Hz) by treating the active shots as if they were noise. In some embodiments, the measurement technique is based on a least square misfit between the resulting spatial auto-correlation function (SPAC), as a function of distance, and a Bessel function. The misfit function may be a L1 misfit as a function of distance, calculated frequency by frequency. The misfit function may also include the sign of the derivative of the SPAC and Bessel functions, which may emphasize sensitivity on turning points more robustly than zero-crossings. A 2D phase velocity map may be obtained by making several of such measurements over at least a portion (or all) of the survey area. This is a complementary technique to active surface analysis techniques, and allows 3D shear wave images of the near surface to be resolved to greater depths.

In varying embodiments, the methods and computing systems discussed herein may have one or more of the following benefits or characteristics: 1) applying passive techniques on active data (e.g., data obtained during an active survey); 2) modification of a SPAC approach to analyse correlation in function of distance instead of frequency; 3) computing misfit of the curve instead of zero-crossings; and/or 4) capturing heterogeneity by applying the technique in an overlapping manner for several points over the survey.

Passive techniques may be defined as including any technique that can be applied to seismic data recorded without the presence of a seismic source. By way of example, techniques related to extracting useful information from noise, such as Seismic Interferometry, daylight imaging, Green's function retrieval, or SPAC methods, and other techniques that are not related to characterizing natural (micro)seismic events are within the meaning of a passive technique.

Active techniques may be defined as the characterization of a seismic wavefield generated by an active source.

In some embodiments, an advantage may be realized by treating active data as if it was passive seismic data. In some embodiments, this may include analyzing frequencies below the lowest sweep frequency of the active source, and adapting a SPAC approach.

Under an assumption of an isotropic noise field, the shape of the spatial autocorrelation as a function of angular frequency (ω) and distance (r) resembles a Bessel function. The spatial autocorrelation curve (ρ) may be described by

$$ρ ( r , ω ) = \frac{1}{2 π} {\int }_{0}^{2 π} \frac{Re [ {S}_{CX} ( ω , r , θ ) ]}{\sqrt{{S}_{C} ( ω ) \cdot {S}_{X} ( ω , r , θ )}} d θ \approx {J}_{0} ( k , {r}_{CX} ) , \qquad ( 1 )$$

where S_{CX} is the cross-correlation coefficient between two sensors, and S_{C} and S_{X} are autocorrelation coefficients. J₀ is the zero^{th} order Bessel function of the 1^{st} kind, and k represents wave-number. The average phase velocity under the array may then be determined by comparing the zero-crossings of the Bessel and observed correlation function

$$c ( {ω}_{n} ) = \frac{{ω}_{n} r}{{z}_{n}} . \qquad ( 2 )$$

Here, zₙ corresponds to the n-th zero-crossing of the Bessel function, and ωₙ to the angular frequency of the zero-crossing belonging to the autocorrelation function. Therefore, equation (2) may be solved as a function of frequency. The shape of the Bessel function over the entire measurement range (distance) may be considered for discrete measurements in addition to zero-crossings (e.g., other measurements in addition to zero-crossings).

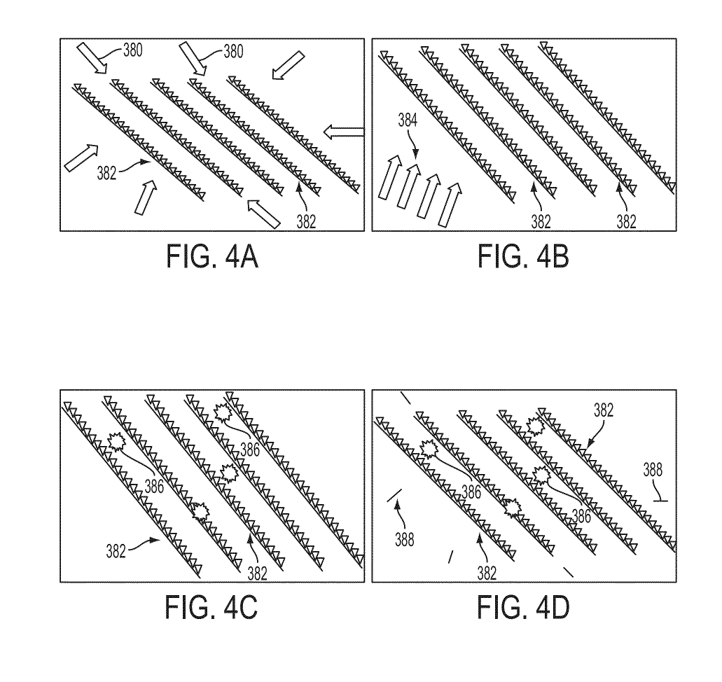

SPAC may be considered a near field or local approach to seismic interferometry. In seismic interferometry, and with reference to FIG. 4A, prevalent noise sources 380 are considered isotropic (coming from many directions) relative to sensors 382. With reference to FIG. 4B, consistent and strong directional noise 384 may result in undesired energy on the imaginary component, which may result in different estimations with different azimuths.

In some embodiments, directivity may be addressed by comparing SPAC values estimated from pairs of receivers with different azimuthal orientations. With a full azimuthal coverage, SPAC results may produce an average. With a one-dimensional (inline) configuration, averaging may not be possible depending on the circumstances.

With reference to FIGS. 4C and 4D, in an active survey, noise sources 386 (e.g., noise from a stationary vibroseis trucks) may be between the sensors 382. Noise sources 388 may also be present. Local measurement (e.g., considering receivers within 1-2 wavelengths), may reduce or avoid this type of noise.

In an application of SPAC in accordance with some embodiments, cross-correlations may be computed between a circular array of single sensors (for angles θ) with fixed radius r around one at the centre (which may be referred to as a virtual source). Circular array applications may be modified to an application(s) along a line. As another modification, a single frequency may be considered, and eq. (3) may be solved for c with varying distance r. To improve on the stability of the measurement, instead of focusing on zero-crossings, in some embodiments, a least-squares misfit between the Bessel function and entire measured SPAC curve (for N receivers) over a range of search velocities (c) may be estimated:

M(c)=Σᵢ₌^{N}J₀(k,rᵢ)²−ρ(rᵢ,ω)². (3)

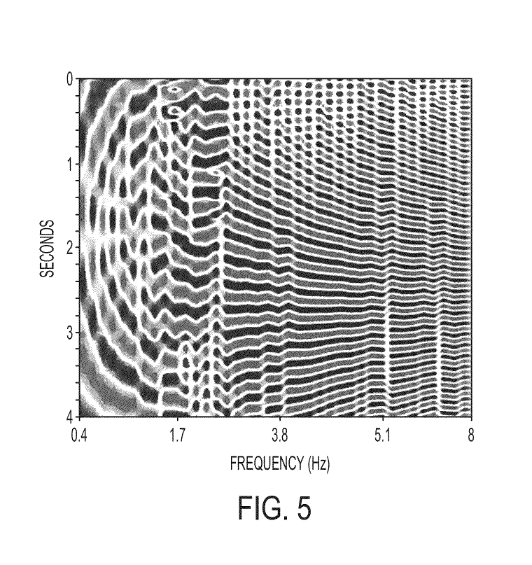

Similar pre-processing as used in interferometry may be applied before the minimization (or reduction) of the misfit M under the condition that low frequencies may be treated as noise. Normalization may be achieved by ignoring amplitude and using phase information after decomposition in the time domain. FIG. 5 illustrates a result for one trace, considering frequencies between 0.4 and 8 Hz. After this step, a time trace for selected frequencies may be further processed to produce (single frequency) SPAC curves from which phase velocity measurements may be performed.

In the example below, the principle is demonstrated for a single frequency (2 Hz), but may also be extended to several discretely sampled frequencies. A grid of locations (virtual sources) is assigned on which the SPAC measurement may be performed. This provides average phase velocities at these virtual sources, which are then interpolated to provide a phase-velocity map of the survey area.

An example embodiment of one method described herein is first illustrated using point-receiver data with receivers that are spaced 6.67 m in the inline direction, and 320 m in the cross-line direction. In this example, the shots were recorded by the receivers, providing a total of 17500 uncorrelated shot records that are 8 seconds long. The data are pre-processed by 1) backing off the 18 dB 3 Hz low-cut filter, and 2) applying a narrow band-pass filter around 2 Hz. Subsequently, the data is treated by Green's function retrieval in seismic interferometry: removing mean, trend, time-normalization by converting the trace to sign-bit, cross-correlate and stack.

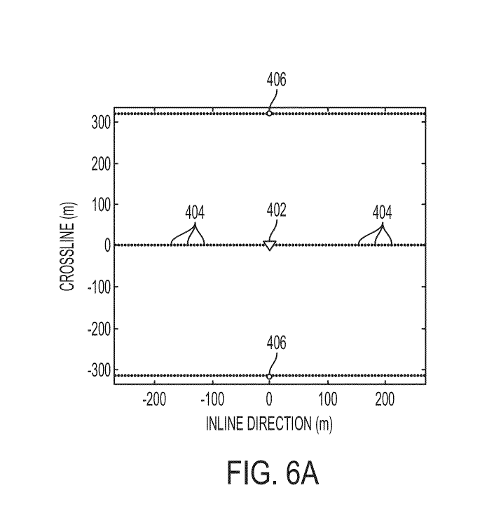

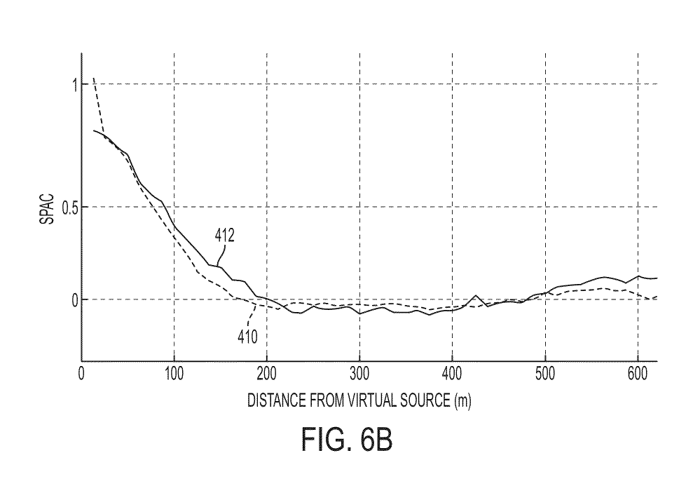

Referring to the example of FIG. 6A, the correlation coefficients between a virtual source location 402 and surrounding point receivers 404 are computed. In some embodiments, the SPAC coefficient is obtained by scaling the correlation coefficient by the autocorrelation of the virtual source point, as described in equation (1).

In some embodiments, the method may operate on the assumption that the noise field does not exhibit specific directionality. The potential directivity issue can be provided by comparing the SPAC values estimated from pairs of receivers with different azimuthal orientation. Consistently strong directional noise sources may result in undesired energy on the imaginary components, and therefore gives different estimations with different azimuths.

In the example of FIG. 6A, a point-receiver acquisition geometry is illustrated in which data is well sampled (e.g., the data has a sample density sufficient to resolve low frequencies and/or the lowest frequency in the seismic survey) in one direction. SPAC coefficients may be estimated at the virtual source position 402 using the inline receivers 404 and two crossline receivers 406.

The method may assume that the ambient active noise (low frequency wavefield recorded during active surveying) is similar to the ambient passive noise (that would have been recorded without survey activity). A field test experiment was conducted in order to test whether ambient active noise may be used. FIG. 6B compares the SPAC curves independently estimated from ambient passive and active noise. Some differences can be distinguished near the first zero-crossing but there is a clear resemblance between the two results. This suggests that ambient active noise is still a good representation of the natural passive noise. This can be explained by the fact that locally man-generated noise is random and small enough and that its potential effect becomes negligible when processing long records thanks to averaging over time.

The example of FIG. 6B illustrates example SPAC curves estimated from ambient active noise 410 (305 records, 2 Hz) and from ambient passive noise 412 (305 records, 2 Hz). These results are obtained from the same amount of records, in total 305·20=6100 seconds of noise. An improved match may be obtained by processing the full dataset (140000 seconds).

As shown by equation 3, average phase velocities at various virtual source positions may be estimated by minimizing the difference between a range of Bessel functions and the measured SPAC curves. In some embodiments, misfit may be computed for a range of phase velocities c between 270-600 m/s and for distance r between 0 and 267 m distance (˜2^{nd} zero-crossing, one wavelength for most points). This length is a measure of averaging and may provide a compromise between smoothness and accuracy of the measurement. In some embodiments, a single frequency is considered and solved for phase velocity. The L1 misfit between the Bessel function and measured SPAC curve (for N receivers, over distance r) may be estimated over a range of search velocities c (eq. 4, first term). The misfit function may include the sign of the derivative (eq. 4, second term), as well as the SPAC curve itself. This term may constrain the positions of the maxima and minima in the presence of residual noise in the Bessel function. Furthermore it may be less biased by the amplitude that can be affected by attenuation. (C is an arbitrary weighting constant between the two terms.

$$Misfit ( c ) = {\sum }_{i = 1}^{N} \vert ρ ( {r}_{i} , f ) - {J}_{0} ( \frac{2 π {fr}_{i}}{c} ) \vert + C {\sum }_{i = 1}^{N} \vert sign ( \frac{\partial ρ}{\partial r} ( {r}_{i} , f ) ) - sign ( \frac{\partial {J}_{0}}{\partial r} ( \frac{2 π {fr}_{i}}{c} ) ) \vert \qquad ( 4 )$$

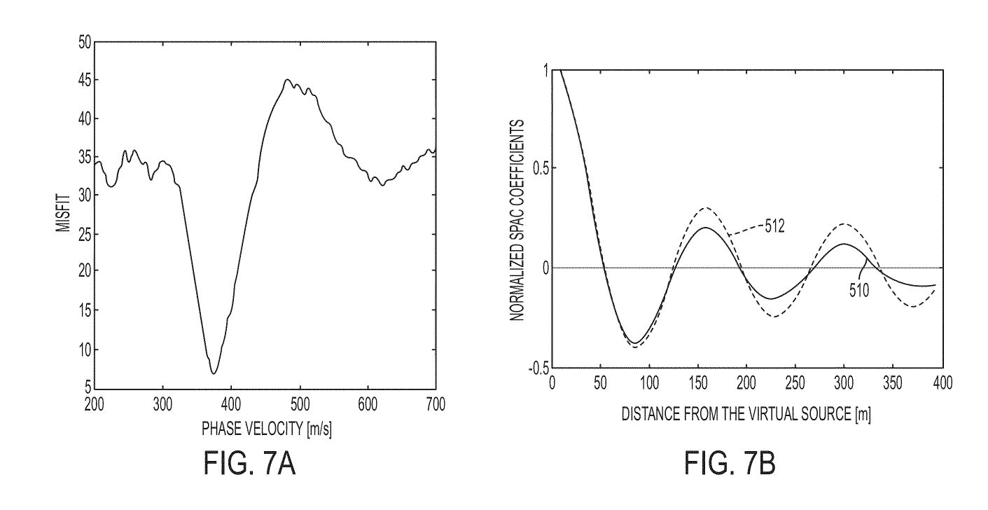

FIG. 7A shows an example calculated misfit curve at a given virtual source. A clear minimum is observed at a velocity of 380 m/s. FIG. 7B shows a corresponding example SPAC curve 510 (e.g., empirical SPAC curve) and a best (or substantially best or improved) matched Bessel function 512 (zero crossing are coincident). Applying this measurement each 200 m provides a regular grid of (18.11=) 198 phase velocity measurements (each basically a smoothed average over the receivers used, an area spanning +/−267 m around the virtual source). The misfit may be calculated for a range of velocities c between 270-600 m/s and for distance r between 0 and 267 m distance (˜2^{nd} zero-crossing, one wavelength for most points). This length is a measure of averaging and will therefore provide a compromise between smoothness and accuracy of the measurement.

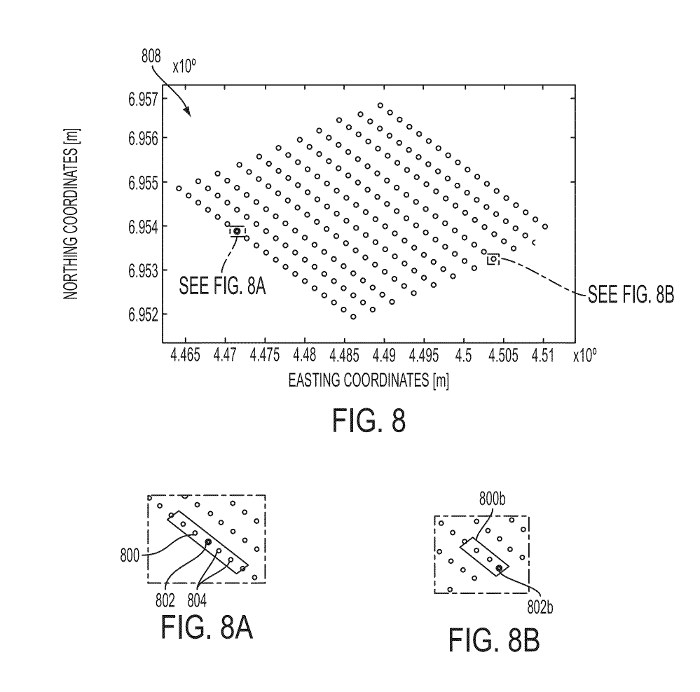

To construct phase velocity maps in accordance with some embodiments, a grid of locations (virtual sources) may be assigned on which the SPAC measurement may be performed. This provides average phase velocities at the virtual sources, which are then interpolated to create a phase-velocity map of the survey area. Referring to FIG. 8A, a window 800 may be provided for a virtual source 802. The SPAC measurement to obtain an average phase velocity may then be performed on the data from the sensors 804 within the window 800. The window 800 may then be shifted across the survey area 808 and the SPAC measurement performed for the remaining virtual sources. The window 800 is one example and other sizes and shapes of windows may be used. With reference to FIG. 8B, the windows 800b is illustrated covering three of the sensors 804. The virtual source may be in the middle of the window (e.g., 800, 802 in FIG. 8A) or it may be provided at other locations in the window (e.g., 800b, 802b in FIG. 8B).

In an example, point-receiver data is provided with receivers that are spaced 6.67 m in the inline direction, and 320 m in the cross-line direction. The shots were recorded by the receivers, providing a total of 17500 uncorrelated shot records that are 8 seconds long. The data may be pre-processed and SPAC curves computed as described in the previous sections. For this example survey, an 18 dB 3 Hz low-cut acquisition filter may be replaced with a 0.5 Hz low cut filter (e.g., by deterministic deconvolution). This may extend the useful bandwidth down to approximately 1.5 Hz.

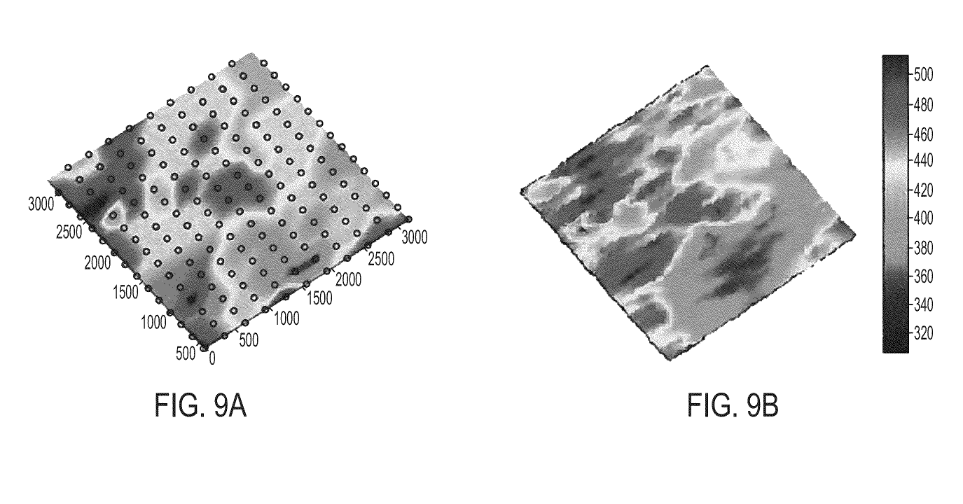

Continuing with this example, applying the SPAC measurement each 200 m provides a regular grid of 209 phase velocity measurements (each represent a smoothed average of the velocity over an area spanning +/−267 m around the virtual source). Interpolation may provide a smooth 3 Hz phase velocity map as shown in FIG. 9A. The result shows good similarities with surface wave analysis results shown in FIG. 9B obtained from frequency-wavenumber spectra of the lowest frequency of the sweep (3 Hz).

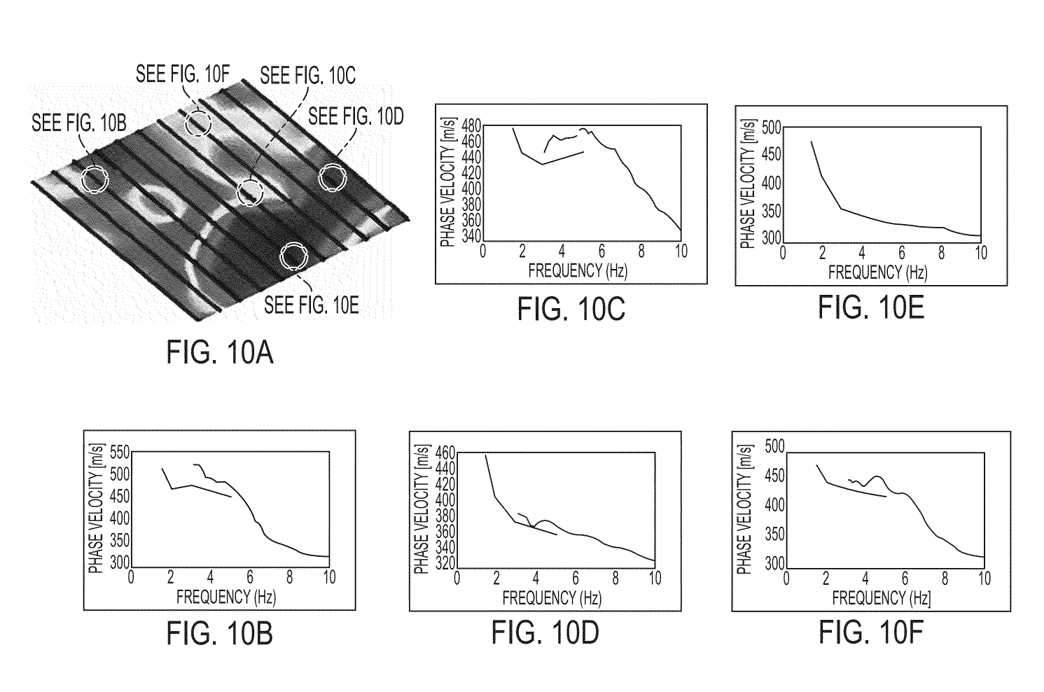

In this field example, phase velocity maps were generated for 4 frequencies: 1.5, 2, 3, 5 Hz. FIGS. 10A-10F illustrate that the resulting dispersion curves (phase velocity as function of frequency) may be merged with the (higher) frequency regime of active surface wave analysis. The mismatch in this field example varied for different locations, but did in general not exceed 10%.

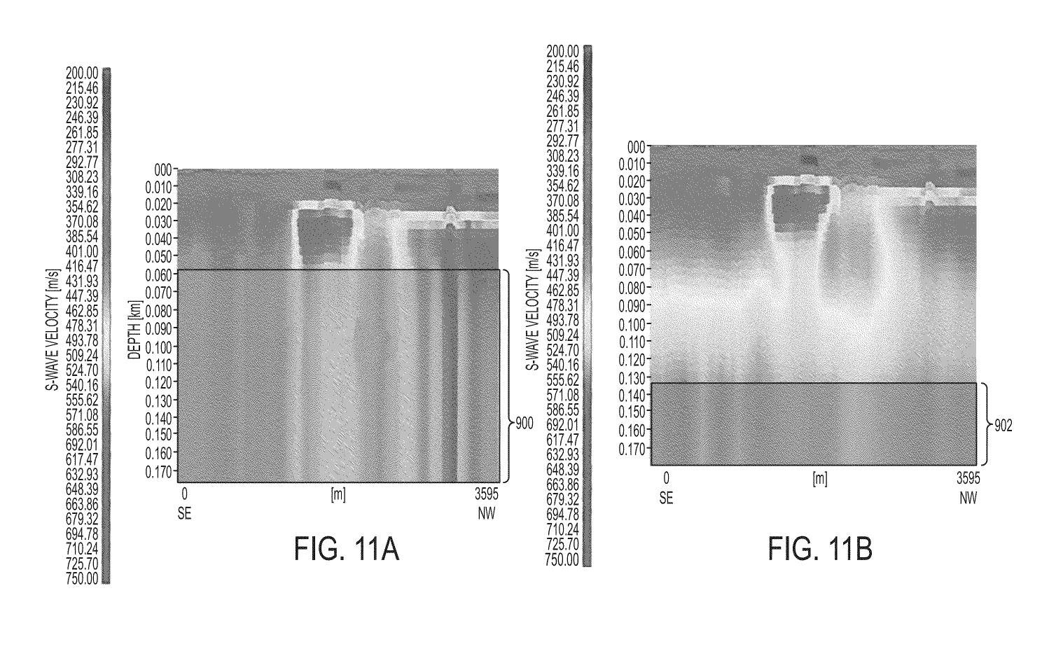

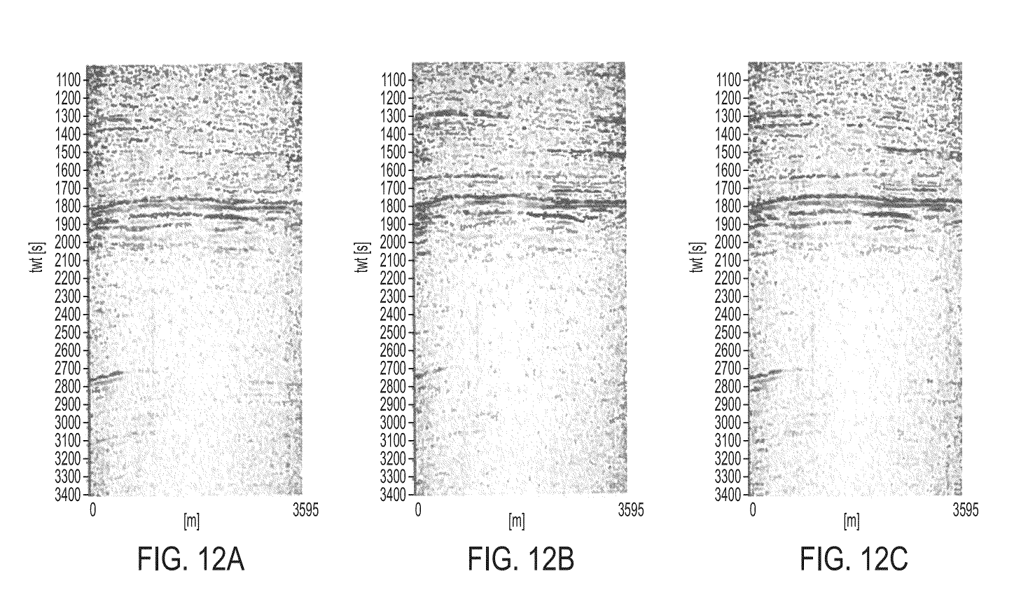

The resulting dispersion volume (c(x,y,f)) may be inverted for a 3D shear wave velocity structure. FIG. 11A illustrates a result based on a computation for active data (5-19 Hz). FIG. 11B illustrates a result including low frequency information obtained by performing the method described herein treating active data as noise in passive data. The same starting model and regularization was used in the examples of FIGS. 11A and 11B. Without the low frequency information, there is no sensitivity to accurately resolve the basement of the near surface structure. The depth resolution increases from around 60 to 130 meters as can be seen in the no sensitivity regions 900 and 902. This is advantageous information in the case of static corrections. FIGS. 12A-12C show the results of static corrections to the final stack, computed using 1) elevation information (FIG. 12A), 2) elevation+near-surface model from active processing (FIG. 12B), and 3) elevation+active+SPAC (FIG. 12C). A relation to translate the Vs to Vp may be used, (Vp=2Vs), the result (for both FIGS. 12B and 12C) may be improved by incorporating a more sophisticated (location dependent) relation. Nevertheless, an improvement may be observed both in terms of continuity and stack power of the reflections at target level.

In some embodiments, receiver geometries may be established to sample azimuths; in alternate embodiments, receiver geometries may be established to sample just the inline direction.

In an embodiment, a method of processing seismic data includes receiving the seismic data and processing the seismic data. The seismic data includes active data corresponding to an active shot from a seismic source. The processing includes processing at least a portion of the active data using a passive data processing technique.

In an embodiment, the processing the active data includes treating the active data as noise in the passive data processing technique.

In an embodiment, the portion of active data is defined by a portion of the frequency spectrum.

In an embodiment, a portion of active data may be identified to treat as noise.

In an embodiment, the identifying is based at least in part on measuring a phase velocity of surface waves present in the seismic data.

In an embodiment, the active shot corresponds to an input source having a lowest frequency, and the processing includes processing, using the passive data processing, a frequency below the lowest frequency.

In an embodiment, a seismic source that generates the received seismic data is a Vibroseis, and the processing includes generating a phase velocity map based on at least one frequency below the bandwidth of a sweep of the Vibroseis.

In an embodiment, the processing includes identifying a virtual source.

In an embodiment, the passive data processing technique includes calculating a spatial auto-correlation function.

In an embodiment, the processing includes calculating a Bessel function.

In an embodiment, the processing includes calculating a misfit between a result of the spatial auto-correlation function and a result of the Bessel function.

In an embodiment, the calculating a misfit includes calculating a least square misfit.

In an embodiment, the calculating a misfit includes calculating a misfit based on a sign of a derivative of the spatial auto-correlation function of the Bessel function.

In an embodiment, pre-processing is performed in a time-frequency domain to provide a normalized time trace.

In an embodiment, the seismic data is obtained in a seismic survey including an active seismic source.

In an embodiment, the seismic data includes data collected by sensors that obtain measurements resulting from noise sources from different azimuthal orientations.

In an embodiment, a computing system includes at least one processor, at least one memory, and one or more programs stored in the at least one memory. The programs include instructions, which when executed by the at least one processor, are configured to perform a method described herein.

In an embodiment, a method includes receiving seismic data and processing, by a processor, the seismic data. The seismic data includes active data corresponding to an active shot from a seismic source. The processing includes selecting a virtual source position, and identifying a window corresponding to the virtual source

In an embodiment, processing includes identifying a window corresponding to the virtual source.

In an embodiment, the window corresponds to a set of data, the set of data corresponds to data from sensors in a seismic survey, and the virtual source is disposed in a region covered by the set of data.

In an embodiment, the processing includes iteratively shifting the window for a plurality of virtual sources.

In an embodiment, a phase velocity measurement is assigned to each virtual source position. In between the virtual sources is interpolated to generate a phase velocity map.

In an embodiment, at least two of the respective windows overlap for different virtual sources.

While some examples herein demonstrate processing for a single frequency (e.g., 2 Hz), application over several discretely sampled frequencies may be used in accordance with the techniques, methods, and computing systems disclosed herein.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the disclosure.

### Computing Systems

FIG. 13 depicts an example computing system 1100 in accordance with some embodiments. The computing system 1100 can be an individual computer system 1101A or an arrangement of distributed computer systems. The computer system 1101A includes one or more geosciences analysis modules 1102 that are configured to perform various tasks according to some embodiments, such as one or more methods disclosed herein. To perform these various tasks, geosciences analysis module 1102 executes independently, or in coordination with, one or more processors 1104, which is (or are) connected to one or more storage media 1106A. The processor(s) 1104 is (or are) also connected to a network interface 108 to allow the computer system 1101A to communicate over a data network 1110 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be on a ship underway on the ocean, while in communication with one or more computer systems such as 1101C and/or 1101D that are located in one or more data centers on shore, other ships, and/or located in varying countries on different continents). Note that data network 1110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 1106A can be implemented as one or more computer-readable or machine-readable storage media. Note that while in the example embodiment of FIG. 13 storage media 1106A is depicted as within computer system 1101A, in some embodiments, storage media 1106A may be distributed within and/or across multiple internal and/or external enclosures of computing system 1101A and/or additional computing systems. Storage media 1106A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 1101A is one example of a computing system, and that computer system 1101A may have more or fewer components than shown, may combine additional components not depicted in the example embodiment of FIG. 13, and/or computer system 1101A may have a different configuration or arrangement of the components depicted in FIG. 13. The various components shown in FIG. 13 may be implemented in hardware, software, or a combination of both, hardware and software, including one or more signal processing and/or application specific integrated circuits.

It should also be appreciated that while no user input/output peripherals are illustrated with respect to computer systems 1101A, 1101B, 1101C, and 1101D, many embodiments of computing system 1100 include computing systems with keyboards, mice, touch screens, displays, etc. Some computing systems in use in computing system 1100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the disclosure.

The computing systems, methods, processing procedures, techniques and workflows disclosed herein are more efficient and/or effective methods for identifying, isolating and/or processing various aspects of seismic signals returned from the earth during a survey.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While the discussion of related art in this disclosure may or may not include some prior art references, applicant neither concedes nor acquiesces in the position that any given reference is prior art or analogous prior art.

The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to explain the principles of the disclosure and its practical applications, to thereby enable others skilled in the art to utilize the disclosure and various embodiments with various modifications as are suited to the particular use contemplated.

What is claimed is:

1. A method, comprising:
receiving seismic data, the seismic data including active data corresponding to an active shot from a seismic source; and
processing, by a processor, at least a portion of the active data using a passive data processing technique.

2. The method of claim 1, wherein the portion of the active data is defined by a portion of the frequency spectrum.

3. The method of claim 1, further comprising identifying a portion of the active data to treat as noise.

4. The method of claim 3, wherein the identifying is based at least in part on measuring a phase velocity of surface waves present in the seismic data.

5. The method of claim 1, wherein
the active shot corresponds to an input source having a lowest frequency, and
the processing includes processing, using the passive data processing, a frequency below the lowest frequency.

6. The method of claim 5, wherein
a seismic source that generates the received seismic data is a Vibroseis, and
the processing includes generating a phase velocity map based on at least one frequency below the bandwidth of a sweep of the Vibroseis.

7. The method of claim 1, wherein the processing includes identifying a virtual source.

8. The method of claim 1, wherein the passive data processing technique includes calculating a spatial auto-correlation function.

9. The method of claim 8, wherein the processing includes calculating a misfit between a result of the spatial auto-correlation function and a result of a Bessel function.

10. The method of claim 9, wherein the calculating a misfit includes calculating a least square misfit.

11. The method of claim 9, wherein the calculating a misfit includes calculating a misfit based on a sign of a derivative of the spatial auto-correlation function of a Bessel function.

12. The method of claim 1, further comprising obtaining the seismic data in a seismic survey including an active seismic source.

13. The method of claim 1, wherein the seismic data includes data collected by sensors that obtain measurements resulting from noise sources from different azimuthal directions.

14. A computing system comprising at least one processor, at least one memory, and one or more programs stored in the at least one memory, wherein the programs comprise instructions, which when executed by the at least one processor, are configured to perform the method of claim 1.

15. A method, comprising:
receiving seismic data, the seismic data including active data corresponding to an active shot from a seismic source; and
processing, by a processor, the seismic data, the processing including selecting a virtual source position, and identifying a window corresponding to the virtual source.

16. The method of claim 15, wherein
the window corresponds to a set of data,
the set of data corresponds to data from sensors in a seismic survey, and
the virtual source is disposed in a region covered by the set of data.

17. The method of claim 16, wherein the processing includes iteratively shifting the window for a plurality of virtual sources.

18. The method of claim 17, further comprising
assigning a phase velocity measurement to each virtual source; and
interpolating in between the virtual sources to generate a phase velocity map.

19. The method of claim 17, wherein at least two of the respective windows overlap for different virtual sources.

20. A non-transitory computer readable storage medium, which has stored therein one or more programs, the one or more programs comprising instructions, which when executed by a processor, cause the processor to perform the method comprising:
receiving seismic data, the seismic data including active data corresponding to an active shot from a seismic source; and
processing at least a portion of the active data using a passive data processing technique.
